(19) United States
(12) Patent Application Publication
(10) Pub. No.: US 2009/0166920 A1
(43) Pub. Date: Jul. 2, 2009

(54) Molding apparatus, method of manufacturing molding apparatus, and molding method

(76) Inventors: Ryuichi Tokunou, Chiba (JP); Toru Hirata, Kanagawa (JP)

Correspondence Address: SQUIRE, SANDERS & DEMPSEY L.L.P., 8000 TOWERS CRESCENT DRIVE, 14TH FLOOR, VIENNA, VA, 22182-6212, US

(21) Appl. No.: 11/988,644

(22) PCT Filed: Jul. 12, 2006
(86) PCT No.: PCT/JP2006/313828

§ 371 Date: Jan. 11, 2008

(51) Int. Cl. B29C 33/42; B29C 35/02; B29C 43/52

(52) U.S. Cl. 264/219; 425/405.1; 425/407; 264/328.16

(57) ABSTRACT

A molding apparatus includes: a heat insulting member; a heat conducting member disposed in a partial surface area of the heat insulating member, the heat conducting member being made of material having a thermal conductivity higher than that of the heat insulating member and including a design surface formed with a molding pattern on a surface on an opposite side to the heat insulating member; a heater for heating a surface layer of the heat conducting member on the design surface side, from the inside of the heat conducting member; and a flow pass disposed between the heat insulating member and design plate and flowing a thermal medium for thermal exchange with the heat conducting member.

### BACKGROUND OF THE INVENTION

A) Field of the Invention

The present invention relates to a molding apparatus and a method of manufacturing a molding apparatus, and more particularly to a molding apparatus capable of heating or cooling a design surface formed with a molding pattern and a method of manufacturing the molding apparatus. The present invention relates also to a molding method using a molding apparatus having a flow pass for flowing a medium to cool a design surface.

B) Description of the Related Art

Techniques are widely known according to which a die is filled with melted molding material and a molding pattern formed on the design surface of the die is transferred to the molding material.

If a temperature of molding material injected into the die lowers and fluidity is degraded, concave portions of a molding pattern cannot be filled properly with the molding material, and a transfer precision cannot be increased. If the die is heated and a temperature lowering of the molding material is suppressed, the transfer precision can be increased.

After the molding pattern is transferred to the molding material, it is desired to quickly cool and solidify the molding material in order to improve productivity. By cooling the die, cooling the molding material can be enhanced.

A molding apparatus having a mechanism for heating and cooling a die has been disclosed. For example, JP-A-2000-823 discloses a molding apparatus described below. As shown in FIG. 7A, this molding apparatus has a first layer 103 made of nonconductive heat insulating material formed on a mold base 102 formed therein with a cooling water flow pass 101. A planar heater 104 which generates heat when energized is formed on the first layer 103, and a second layer 105 made of nonconductive material is formed on the planar heater 104. A surface member 106 having a design surface is formed on the second layer 105.

A molding apparatus described below is disclosed, for example, in JP-A-HEI-8-156028. As shown in FIG. 7B, this molding apparatus has a core block 202 fitted in a movable die 201, and a high temperature air flow pass 203 and a cooling medium flow pass 204 are formed in the core block 202. A heat insulating layer 205 made of an air layer is formed between the core block 202 and movable die 201. A cavity block 202a is fitted in a fixed die 201a, and a cooling medium flow pass 204a is formed in the cavity block 202a. A heat insulating layer 205a made of an air layer is formed between the cavity block 202a and fixed die 201a. A cavity 206 exposing a design surface is defined between the core block 202 and cavity block 202a.

The core block 202 and cavity block 202a are made of aluminum alloy to reduce a heat capacity. A preferable thickness of each of the core block 202 and cavity block 202a is 20 to 40 mm.

As shown, in a state that the core block 202 and cavity block 202a are not closed completely but are slightly opened, the high temperature air flow pass 203 is opened in a space between the core block 202 and cavity block 202a. In this state, as high temperature air is flowed through this space, the design surface exposed in this space is heated. After heating the design surface, the core block 202 and cavity block 202a are closed completely, and the cavity 206 is filled with molding material to transfer a molding pattern.

The design surface can be heated and cooled by using the molding apparatus disclosed in JP-A-2000-823 and JP-A-HEI-8-156028.

In the molding apparatus of JP-A-2000-823, the first layer made of heat insulating material is involved between the cooling water flow pass and the surface member having the design surface. Therefore, the design surface cannot be cooled efficiently. By using the molding apparatus of JP-A-HEI-8-156028, the design surface can be cooled efficiently, because no heat insulating layer is involved between the cooling medium flow pass and the design surface.

However, in the molding apparatus of JP-A-HEI-8-156028, the design surface is heated from the cavity side. Therefore, while the cavity is filled with the molding material, the design surface cannot be heated. It is not easy to maintain the design surface at a desired temperature or higher during transfer of the molding pattern.

A recent tendency is that a molding pattern becomes finer, and it is desired to manufacture a molding apparatus suitable for transferring a fine molding pattern. It is desired to provide a design surface heating or cooling mechanism suitable for making compact a molding apparatus.

In a molding apparatus, molding material is pushed against the design surface to transfer a molding pattern to the molding material. In the molding apparatus equipped with a cooling medium flow pass such as disclosed in JP-A-2000-823 and JP-A-HEI-8-156028, as molding material is pushed against the design surface, a force is likely to be applied, which may deform the cooling medium flow pass. There is therefore a fear of damaging the flow pass.

### SUMMARY OF THE INVENTION

An object of this invention is to provide a molding apparatus having a structure suitable for compacting the molding apparatus.

Another object of the present invention is to provide a molding apparatus which can cool a design surface efficiently and is easy to maintain the design surface at a desired temperature or higher while a molding pattern formed on the design surface is transferred to molding material.

Still another object of the present invention is to provide a molding apparatus suitable for properly heating a design surface.

Still another object of the present invention is to provide a manufacture method suitable for manufacturing the above-described molding apparatus.

Still another object of the present invention is to provide a molding method applicable to a molding method for molding material using a molding apparatus equipped with a cooling medium flow pass and capable of suppressing damages of the flow pass.

According to a first aspect of the present invention, there is provided a molding apparatus comprising: a first member; a second member disposed in a partial surface area of the first member, the second member including a design surface formed with a molding pattern on a surface on an opposite side to the first member; and a flow pass whose inner wall is defined cooperatively by a surface of the first member and a surface of the second member, the flow pass flowing therein a thermal medium for heat exchange with the second member.

According to a second aspect of the present invention, there is provided a molding apparatus comprising: a first member; a second member disposed in a partial surface area of the first member, the second member including a design surface formed with a molding pattern on a surface on an opposite side to the first member, and being made of material having a higher thermal conductivity than a thermal conductivity of the first member; a heater that heats a surface layer of the second member on a side of the design surface, from an inside of the second member; and a flow pass disposed between the first member and the design surface, that flows thermal medium for heat exchange with the second member.

According to a third aspect of the present invention, there is provided a molding apparatus comprising: a third member including a design surface formed with a molding patter; and a heater disposed on the third member that heats a surface layer of the third member on a side of the design surface, wherein a shortest distance from the heater to the design surface is five to ten times a maximum depth of concave portions of the design surface.

According to a fourth aspect of the present invention, there is provided a manufacture method for a molding apparatus, comprising steps of: (a) partially etching a first surface of a first member to form a groove; and (b) bonding said first surface of said first member to a second surface of a second member, the second member including a design surface formed with a molding pattern opposite to the second surface, said second member being made of material having a thermal conductivity higher than a thermal conductivity of said first member, to form a flow pass defined by an inner wall of said groove and the second surface of said second member.

According to a fifth aspect of the present invention, there is provided a manufacture method for a molding apparatus comprising steps of: (g) laminating a transfer structural body including a design surface formed with a molding pattern, on a surface of an insulating support member made of material having electrical insulation; (h) forming a conductive layer made of conductive material on a surface of the insulating support member on an opposite side to a side laminating the transfer structural body; and (i) patterning the conductive layer to form a heater.

According to a sixth aspect of the present invention, there is provided a molding method comprising steps of: (j) pushing molding material against a design surface of a structural body including the design surface formed with a molding pattern on a surface and a flow pass therein that flows a thermal medium for heat exchange with the design surface; and (k) changing at least one of a pressure applied to the thermal medium in the flow pass and a flow rate of the thermal medium flowing in the flow pass, synchronously with a timing when the molding material is pushed against the design surface, to increase a pressure applied to an inner wall of the flow, pass by the thermal medium.

In the molding apparatus according to the first aspect of the present invention, the inner wall of the flow pass is defined cooperatively by the surface of the first member and the surface of the second member. Namely, the flow pass is formed by adhering the surface of the first member to the surface of the second member. Since the flow pass is formed neither in the first member nor in the second member, the flow pass can be formed easily even if the first or second member is made small.

In the molding apparatus according to the second aspect of the present invention, the flow pass for heat exchange with the second member is disposed between the first member and design surface. The design surface can therefore be cooled efficiently. The heater heats the surface layer of the second member on the design surface side, from the inside of the second member. It is therefore easy to maintain the design surface at a desired temperature or higher, while the molding pattern formed on the design surface is transferred to molding material.

In the molding apparatus according to the third aspect of the present invention, the shortest distance from the heater to design surface is adjusted to be 5 to 10 times the maximum depth of the concave portions of the design surface. Therefore, for example, the design surface can be heated easily while temperature distribution irregularity is suppressed.

In the manufacture method for a molding apparatus according to the fourth aspect of the present invention, the flow pass is formed by adhering the surface of the first member formed with the groove to the surface of the second member. A micro flow pass can therefore be formed easily.

In the manufacture method for a molding apparatus according to the fifth aspect of the present invention, the heater is formed by patterning the conductive layer. Therefore, for example, a micro heater can be formed easily.

In the molding method according to the sixth aspect of the present invention, a pressure applied to the inner wall of the flow pass by a thermal medium is increased synchronously with a timing when the molding material is pushed against the design surface. It is therefore possible to suppress the inner wall of the flow pass from being deformed and the flow pass from being damaged, otherwise to be caused by the molding material being pushed against the design surface.

### BRIEF DESCRIPTION OF THE DRAWINGS

FIG. 1 is a schematic cross sectional view of a molding apparatus according to a first embodiment of the present invention.

FIG. 2A is a cross sectional view of a plunger 4, and FIG. 2B is a plan view of the plunger 4.

FIGS. 3A to 3F are cross sectional views illustrating a manufacture method for a design surface side structural body 4A which is part of the plunger 4.

FIGS. 4A to 4D are cross sectional views illustrating a manufacture method for a support member side structural body 4B which is part of the plunger 4.

FIG. 5A is a cross sectional view of a plunger upper structural body 4C illustrating a method of bonding together the design surface side structural body 4A and support member side structural body 4B, and FIG. 5B is a cross sectional view of a support member 20 which is part of the plunger 4.

FIG. 6 is a timing chart illustrating a change during a molding process in a pressure applied to a design surface 4a by molding material, a pressure applied to cooling water by a pump 6c, a flow rate of cooling water passing through a valve 6d, and a current flowing through a heater H.

FIGS. 7A and 7B are schematic cross sectional views of molding apparatus according conventional techniques.

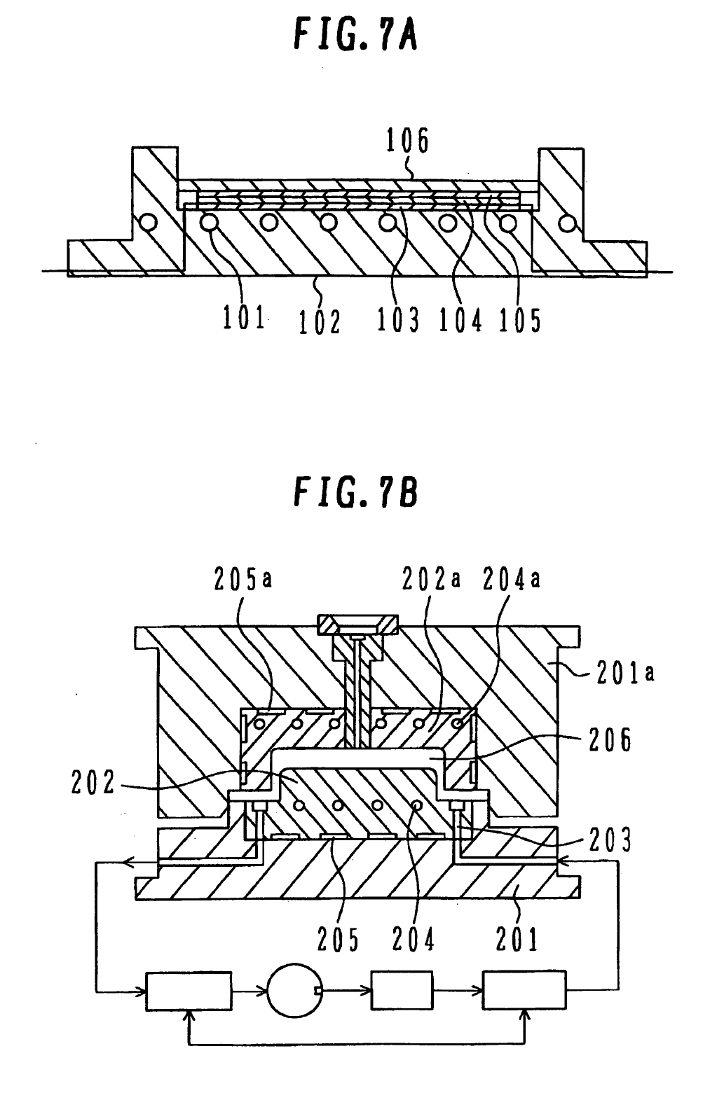

FIGS. 8A and 8B are schematic diagrams showing a molding apparatus according to a second embodiment of the present invention.

FIG. 9 is a graph illustrating a molding method for the molding apparatus of the second embodiment.

FIG. 10 is a plan view showing an example of the shape of a flow pass and a heater.

### DESCRIPTION OF THE PREFERRED EMBODIMENTS

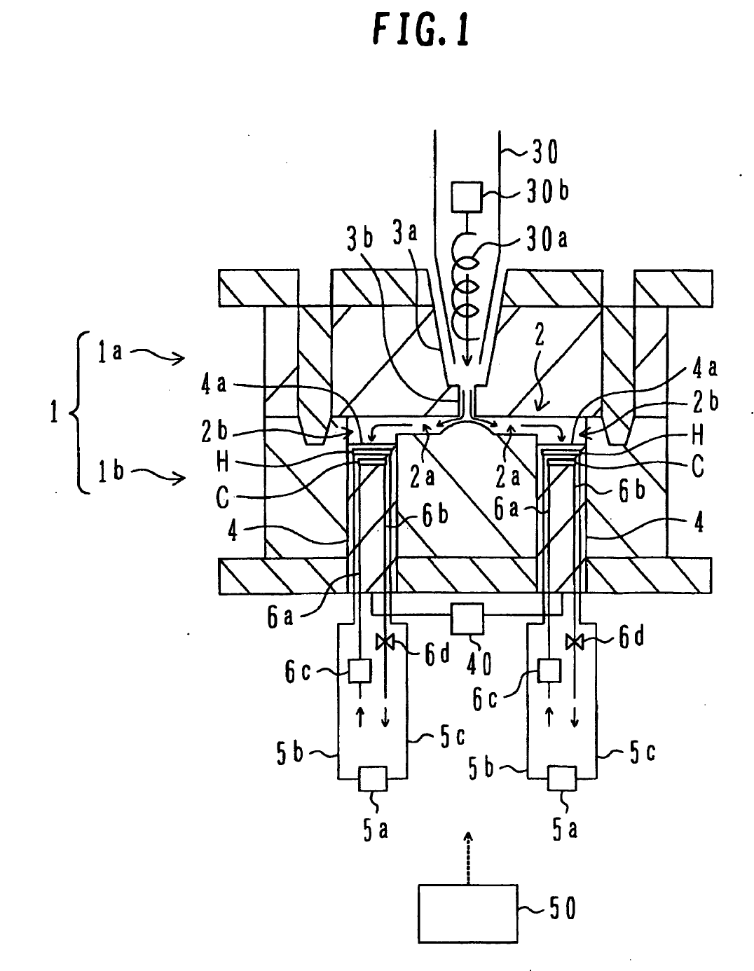

FIG. 1 is a schematic cross sectional view of a molding apparatus according to the first embodiment of the present invention. A die 1 is constituted of a fixed die 1a and a movable die 1b. In a state that the die 1 is closed, a space 2 including a runner 2a and a cavity 2b is defined between the fixed die 1a and movable die 1b.

As a screw 30a disposed in a cylinder 30 is rotated, molding material in a melted state is ejected from the cylinder 30. Molding material is resin such as polycarbonate. A drive mechanism 30b drives the screw 30a. The molding material ejected from the cylinder 30 is injected into the space 2 via a nozzle 3a and a spool 3b formed in the fixed die 1a. The cavity 2b is filled with the molding material injected into the space 2, via the runner 2a.

A plunger 4 is assembled in the movable die 1b, the plunger 4 having a design surface 4a formed with a molding pattern. The design surface 4a defines a portion of the inner wall of the cavity 2b. A drive mechanism 40 moves the plunger 4 to narrow the cavity 2b, synchronously with while the cavity 2b is filled with the molding material.

The molding material is pushed against the design surface 4a by the pressure that the screw 30a injects the molding material into the cavity 2b. The pressure of pushing the molding material against the design surface 4a increases further as the plunger 4 moves toward the cavity 2b side. As the molding material is pushed against the design surface 4a, a molding pattern is transferred to the surface of the molding material. A controller 50 controls the drive mechanism 30b for the screw 30a and the drive mechanism 40 for the plunger 4 so that the molding material is pushed against the design surface 4a at a desired timing and at a desired pressure.

A heater H for generating heat upon energization is assembled in the plunger 4. The design surface 4a can be heated with the heater H. A power source 5a is connected to the heater H via lead wires 5b and 5c. The controller 50 controls the power source 5a of the heater H.

The heater H heats the design surface 4a in such a manner that the molding material injected into the cavity 2b maintains a sufficiently melted state until concave portions of the molding pattern of the design surface 4a are properly filled with the molding material. Since the concave portions of the molding pattern can be filled properly with the molding material, a transfer precision is improved.

A flow pass C is also assembled in the plunger 4, cooling water capable of cooling the design surface 4a flowing through the flow pass. The flow pass C is connected to a water feed flow pass 6a and a water drain flow pass 6b formed in the plunger 4. A pump 6c regulates a pressure of the cooling water flowing through the flow pass 3. A valve 6d regulates a flow rate of the cooling water draining from the flow pass C. The controller 50 controls the pump 6c and valve 6d.

After the molding pattern is transferred to the molding material, cooling water is flowed through the flow pass C to cool the design surface 4a. Since the molding material can be cooled and solidified quickly, productivity can be improved.

The plunger 4 can be dismounted from the movable die 1b, and can be exchanged with another plunger having a design surface formed with another molding pattern.

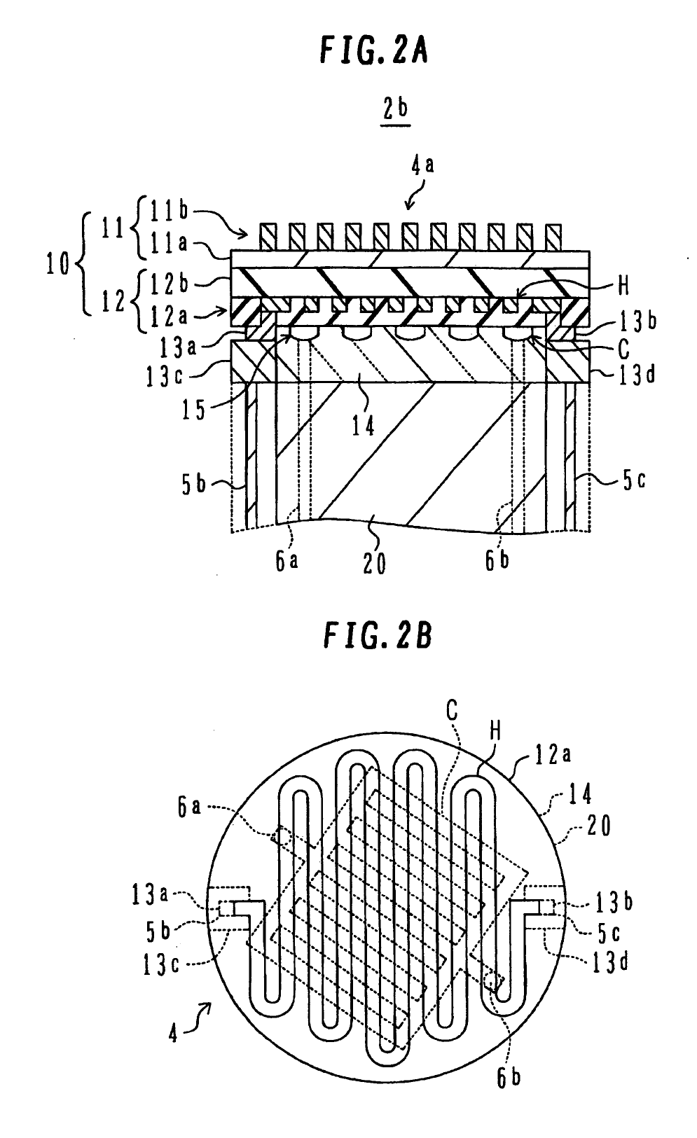

Next, with reference to FIGS. 2A and 2B, the plunger 4 will be described more in detail. FIG. 2A is a cross sectional view showing an area near the design surface 4a of the plunger 4. A heat insulating member 14 is mounted on a support member 20. The support member 20 is made of metal such as SUS, and the heat insulating member 14 is made of, for example, Pyrex (registered trademark) glass. A thickness of the heat insulating member 14 is, for example, 1 to 2 mm. A groove 15 is formed in the upper surface layer of the heat insulating member 14.

A silicon member 12 made of silicon having electrical insulation is mounted on the heat insulating member 14. A thickness of the silicon member 12 is, for example, 150 μm. The silicon member 12 has a lamination structure of a lower silicon member 12a and an upper silicon member 12b stacked in this order from the heat insulating member 14 side. A heat conductivity of the lower and upper silicon members 12a and 12b is higher than that of the heat insulating member 14.

The lower silicon member 12a is disposed on the upper surface of the heat insulating member 1 to seal the opening of the groove 15 (to cover the opening). The groove 15 whose opening is sealed with the lower silicon member 12a constitutes the cooling water flow pass C. The water feed flow pass 6a and water drain flow pass 6b extending through the support member 20 and heat insulating member 14 are connected to the flow pass C.

The heater H is disposed between the lower and upper silicon members 12a and 12b, and buried in the silicon member 12. The heater H is made of, for example, nickel chrome alloy, and generates heat upon energization. Electrodes 13a and 13b are connected to the opposite ends of the heater H. The electrodes 13a and 13b extend in the lower silicon member 12a and reaches the lower surfaces of the heater.

Electrode lead pads 13c and 13d made of metal are formed on the side wall of the heat insulating member 14. The electrodes 13a and 13b are connected to the lead wires 5b and 5c via the electrode lead pads 13c and 13d, respectively.

A transfer structural body 11 made of metal such as nickel is formed on the upper silicon member 12b. The transfer structural body 11 is constituted of a thin film seed layer 11a and a plurality of columnar structural bodies 11b formed on the seed layer 11a. The columnar structural body is elongated along a thickness direction of the seed layer 11a. A thickness of the seed layer 11a is, for example, several ten nm, and a height of the columnar structural body 11b is, for example, several ten μm. A surface of the transfer structural body 11 exposed to the cavity 2b constitutes the design surface 4a.

A heat conductivity of the transfer structural body 11 is higher than that of the heat insulting member 14. The silicon member 12 and transfer structural body 11 constitute a heat conductive member 10. A heat conductivity of the heater H buried in the silicon member 12 is also higher than that of the heat insulating member 14.

FIG. 2B is a plan view of the plunger 4, and shows the shape of the heater H and flow pass C. The heater H of a zig-zag line shape is disposed on the surface of the lower silicon member 12a of a disc shape. A line width of the heater H is, for example, 100 μm. Up- and down-direction portions of the heater H as viewed in the drawing are disposed parallel at a center distance (pitch) of, e.g., 200 μm. The electrodes 13a and 13b are connected to the opposite ends of the heater H, and to the electrode lead pads 13c and 13d, respectively. The electrode lead pads 13c and 13d are connected to the lead wires 5b and 5c, respectively.

It is preferable to narrow the line width and pitch of the heater H, from the viewpoint of heating the heater by suppressing temperature distribution irregularity at the design surface. For example, the line width of the heater H is set to about 5 μm to 100 μm. The pitch is set to, for example, about 10 μm to 200 μm twice the line width. In this embodiment, a fine heater H having a line width of 10 μm or narrower can be formed so that localized heating can be performed.

A diameter of the lower silicon member 12a is, for example, 2 to 3 mm. The shape of the heat insulating member 14 and support member 20 as viewed downward is circular matching the shape of the lower silicon member 12a. However, recesses are formed in the heat insulating member 14 in the areas where the electrode 13a and electrode lead pad 13c and electrode 13b and electrode lead pad 13d are formed. Grooves are formed in the side wall of the support member 20 in the areas where the lead wires 5b and 5c are disposed.

The shape of the upper silicon member 12b and seed layer 11a as viewed downward is also circular matching the shape of the lower silicon member 12a. Although the plunger 4 of this embodiment is tubular, the plunger may have other shapes such as a prism shape, when necessary.

The flow pass C is formed under the heater H and between the lower silicon member 12a and heat insulating member 14. Cooling water enters the flow pass C from the water feed flow pass 6a. Cooling water flows in one pass to the flow pass C. This one pass is branched into seven passes which are collected to one pass again, and cooling water drains from the flow pass C to the water drain flow pass 6b. A width of one pass in the flow pass C is, for example, 100 μm. In the area where there are seven flow passes, these seven flow passes are disposed parallel, and adjacent flow passes are disposed, for example, at a center distance (pitch) of 200 μm.

It is preferable to narrow the width and pitch of the flow pass C, from the viewpoint of heating the heater by suppressing temperature distribution irregularity at the design surface. For example, the width of the flow pass C is set to about 5 μm to 100 μm. The pitch is set to, for example, about 10 μm to 200 μm twice the flow pass width. In this embodiment, a fine flow pass C having a width of 10 μm or narrower can be formed so that localized cooling can be performed.

Consider now that instead of the flow pass C, it is assumed that a flow pass constituted of one flow pass not branched (e.g., a flow pass having a zig-zag shape) is disposed in the area where the flow pass C is disposed. A distance of this flow pass from an inlet port to an outlet port is longer than the longest distance of the flow pass C from an inlet port to an outlet port. A pressure loss of the flow pass C can therefore be reduced while the cooling water is flowed from an opening of the water feed flow pass 6a to an opening of the water drain flow pass 6b.

In the molding apparatus described above, as the heater H is powered, the heat conductive member 10 shown in FIG. 2A is heated. Since the heat insulating member 14 is formed under the heat conductive member 10, heat transfer to the support member 20 can be suppressed. Further, no heat insulating member is involved between the heater H and design surface 4a so that the design surface 4a can be heated efficiently.

With this molding apparatus, the surface layer of the design surface 4a can be heated from the inside of the heat conductive member 10. It is therefore easy to maintain the design surface 4a at a desired temperature or higher while the cavity 2b is filled with molding material.

Cooling water flowing through the flow pass C formed between the heat insulating member 14 and heat conductive member 10 contacts the heat conductive member 10 so that heat exchange with the heat conductive member 10 occurs. Since the heat insulating member 14 is formed under the heat conductive member 10, heat transfer from the support member 20 can be suppressed. No heat insulating member is involved between the flow pass C and design surface 4a so that the design surface 4a can be cooled efficiently.

Even if the flow pass C is buried in the silicon member 12, cooling water can perform heat exchange with the heat conductive member 10. However, if the silicon member is as thin as about 200 μm, it is difficult to bury the space corresponding to the flow pass C in the silicon member 12.

In the molding apparatus described above, the flow pass C is formed between the heat insulating member 14 and silicon member 12. The surfaces of the heat insulating member 14 and silicon member 12 define in unison the inner wall of the flow pass C. Since the flow pass C can be formed by bonding together the heat insulating member 14 and silicon member 12, the flow pass can be formed more easily than the flow pass C is buried in the silicon member 12. It is therefore possible to thin the silicon member 12.

The thinner the silicon member 12 is, a heat capacity of the heat conductive member 10 can be reduced so that heating and cooling the heat conductive member 10 can be performed quickly. Namely, heating and cooling the design surface 4a can be performed quickly.

Instead of forming the groove 15 in the upper surface layer of the heat insulating member 14, the flow pass may be formed by forming a groove in the lower surface layer of the lower silicon member 12a and covering an opening of the groove with the upper surface of the heat insulating member 14. A flow pass may also be formed by forming a groove on both upper and lower surface layers of the heat insulating member 14 and lower silicon member 12a, respectively. However, if the groove is formed in the lower surface layer of the lower silicon member 12a, a mechanical strength of the silicon member 12 may be lowered slightly. Therefore, if the silicon member 12 is desired to be formed thin, it is preferable to form a flow pass by forming the groove 15 in the upper surface layer of the heat insulting member 14, without forming the groove in the lower surface layer of the lower silicon member 12a.

The heat insulating member 14 is formed to have a thickness providing a sufficient mechanical strength even if the groove 15 is formed in the upper surface layer. It is preferable that the heat insulating member 14 is thick, from the viewpoint of heat insulation.

Even if the groove is not formed in the lower surface layer of the lower silicon member 12a, the mechanical strength of the silicon member 12 and heat conductive member 10 lowers if the silicon member 12 is made thin. A shortest distance from the flow pass C to design surface 4a (in this embodiment, this distance corresponds to a thickness from the lower surface of the lower silicon member 12a to the upper surface of the seed layer 11a) has some range in which the mechanical strength of the heat conductive member 10 is retained and the design surface 4a is cooled quickly. It is preferable to set the shortest distance between the flow pass C and design surface 4a in a range from 100 μm to 200 μm.

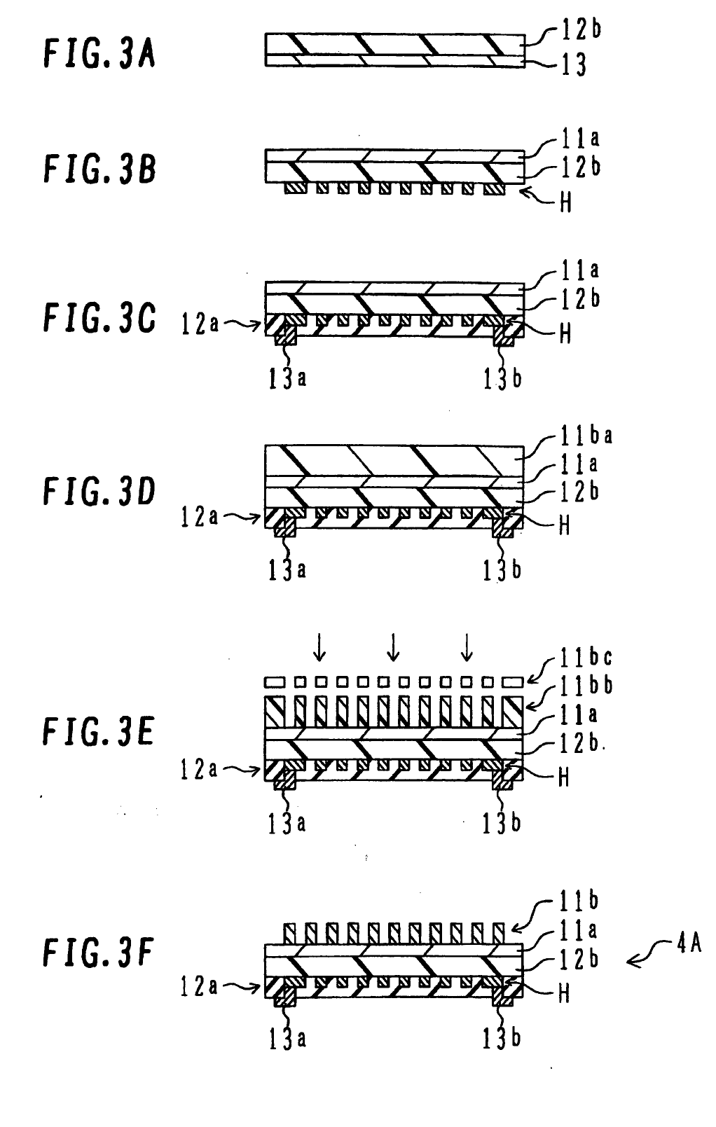

Next, with reference to FIGS. 3A to 3F, FIGS. 4A to 4D, and FIGS. 5A and 5B, description will be made on a manufacture method for the plunger 4. First, with reference to FIGS. 3A to 3F, description will be made on a manufacture method for a design surface side structural body integrating the heat conductive member 10, heater H and electrodes 13a and 13b shown in FIG. 2A.

As shown in FIG. 3A, a conductive film 13 is formed on the lower surface of an upper silicon member 12b. The conductive film 13 is made of, for example, nickel chrome or the like, and formed by physical vapor deposition (PVD) such as sputtering.

Next, as shown in FIG. 3B, the conductive film 13 is patterned to form a heater H. Then, a seed layer 11a is formed on the upper surface of the upper silicon member 12b. For example, the seed layer 11a is made of metal such as nickel and formed by physical vapor deposition.

Next, as shown in FIG. 3C, a lower silicon member 12a is stacked on the lower surface of the upper silicon member 12b. For example, the lower silicon member 12a is formed by growing polysilicon by chemical vapor deposition (CVD).

Next, the lower silicon member 12a is patterned to form recesses exposing the heater H at the bottoms thereof, in areas where electrodes 13a and 13b are to be formed. A metal film is formed on the lower surface of the lower silicon member 12a, burying the recesses. For example, the metal film is made of aluminum and formed by physical vapor deposition. The metal film is patterned to form the electrodes 13a and 13b.

Next, as shown in FIG. 3D, a resist layer 11 ba made of polymethyl methacrylate (PMMA) is formed on the seed layer 11a.

Next, as shown in FIG. 3E, the resist layer 11 ba shown in FIG. 3D is exposed to X-rays via an X-ray mask 11bc. The resist is developed to form a resist pattern 11bb. The seed layer 11a is exposed at the bottoms of concave portions of the resist pattern 11 bb.

Next, as shown in FIG. 3F, the concave portions of the resist pattern 11 bb shown in FIG. 3E are filled with, for example, nickel by electroplating to form a columnar structural body 11b. After the columnar structural body 11b is formed, the resist pattern 11bb is removed. A method of using a resist pattern as a mold formed by X-ray exposure and forming a metal structural body by electroplating is called Lithographie, Galvanoformung, Abformung (LIGA).

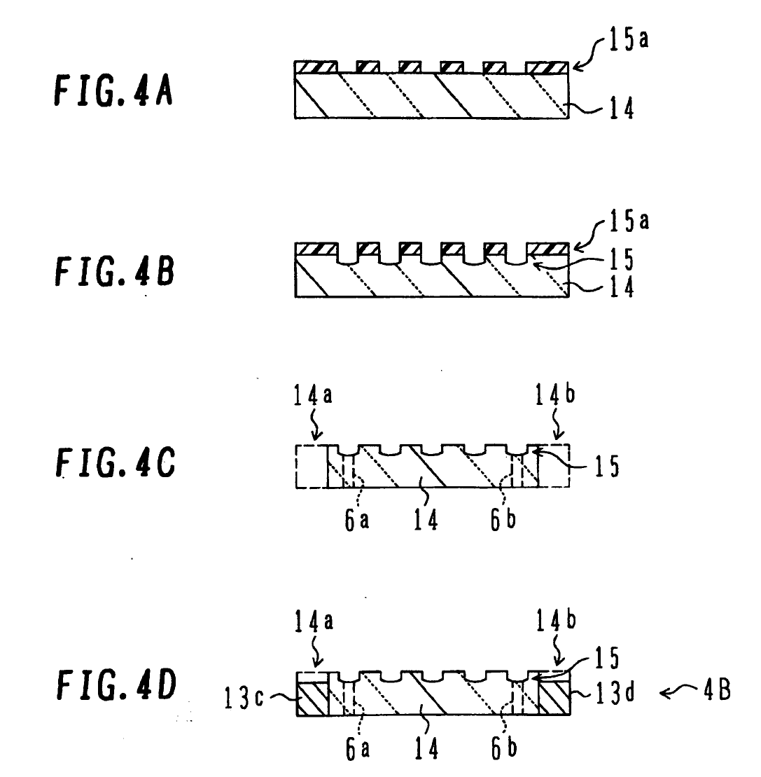

Next, with reference to FIGS. 4A to 4D, description will be made on a manufacture method for the support member side structural body 4B integrating the heat insulating member 14 and electrode lead pads 13c and 13d shown in FIG. 2A. As shown in FIG. 4A, a resist pattern 15a having an opening pattern corresponding to the flow pass C is formed on the upper surface of a heat insulating member 14. The heat insulating member 14 is made of, for example, glass.

Next, as shown in FIG. 4B, a surface layer of the heat insulating member 14 exposed on the opening of the resist pattern 15a is etched to form a groove 15. The resist pattern 15a is thereafter removed.

Next, as shown in FIG. 4C, a water feed flow pass 6a and a water drain flow pass 6b are formed. Then, a recess 14a is formed in the area where the electrode 13a and electrode lead pad 13c are to be formed, and another recess 14b is formed in the area where the electrode 13b and electrode lead pad 13d are to be formed. The flow passes 6a and 6b and recesses 14a and 14b are formed, for example, by laser drilling using CO₂ laser or YAG laser.

Next, as shown in FIG. 4D, the recesses 14a and 14b are filled with metal such as aluminum, lead and tin to form the electrode lead pads 13c and 13d.

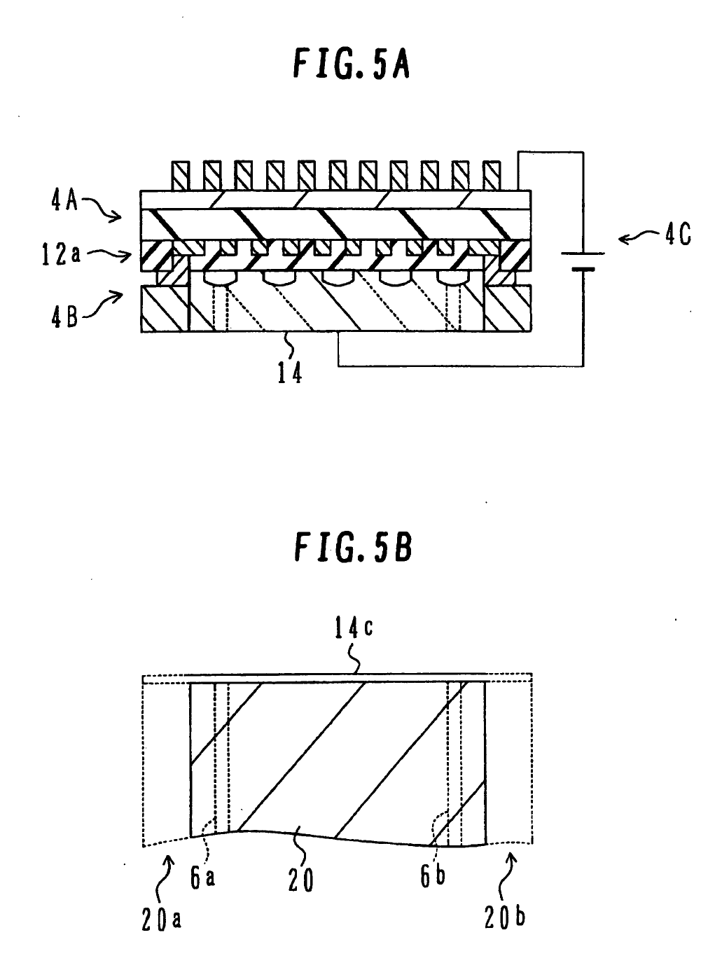

Next, as shown in FIG. 5A, the design surface side structural body 4A and support member side structural body 4B are bonded together to form a plunger upper structural body 4C. If the heat insulating member 14 is made of glass, the design surface side structural body 4A and support member side structural body 4B can be bonded by anode bonding as in the following.

The design surface side structural body 4A and support member side structural body 4B are aligned in position so that the electrodes 13a and 13b of the design surface side structural body 4A take proper positions relative to the electrode lead pads 13c and 13d of the electrode support member side structural body 4B, to thereby make the lower surface of the lower silicon member 12a become in tight contact with the upper surface of the heat insulating member 14.

The design surface side structural body 4A and support member side structural body 4B are heated to about 450° C. for example, and at the same time, voltage is applied to an interface between the lower silicon member 12a and heat insulating member 14, with a positive potential being applied at the lower silicon member 12a. In this manner, the lower silicon member 12a made of silicon can be bonded to the heat insulating member 14 made of glass. This bonding method between a silicon member and a glass member is called anode bonding.

Next, the plunger upper structural body 4C is bonded to a support member 20. As shown in FIG. 5B, the support member 20 is prepared which is formed with the water feed flow pass 6a and water drain flow pass 6b and the grooves 20a and 20b in which the lead wires 5b and 5c are disposed. The water feed flow pass 6a and water drain flow pass 6b and grooves 20a and 20b can be formed, for example, by mechanical drilling.

Water glass 14c is coated on the upper surface of the support member 20, by using a brush for example. The water glass 14c is coated so as not to close the openings of the water feed flow pass 6a and water drain flow pass 6b. A thickness of the water glass 14c is about 1 μm for example. By using the water glass 14c as adhesive, the lower surface of the heat insulating member 14 is bonded to the upper surface of the support member 20.

Position alignment between the plunger upper structural body 4C and support member 20 is performed, for example, in the following manner. A position alignment concave or convex portion is formed on the lower surface of the heat insulating member 14, and a corresponding convex or concave portion is formed on the upper surface of the support member 20. By engaging the concave and convex portions formed on the heat insulating member 14 and support member 20, position alignment between both the members can be achieved. The positions of the concave and convex portions engaged with each other for position alignment are determined so that the water feed flow pass 6a and water drain flow pass 6b formed in the plunger upper structural body 4C are connected to the water feed flow pass 6a and water drain flow pass 6b formed in the support member 20.

After the plunger upper structural body 4C and support member 20 are bonded together, the lead wires 5b and 5c are connected to the electrode lead pads 13c and 13d. The plunger 4 can be formed in the manner described above.

If any vacant space exists in the flow pass C while the molding material is pushed against the design surface 4a, the inner wall of the flow pass C is likely to be deformed and the flow pass C is likely to be damaged. Even if no vacant space exists, the flow pass C may be crushed and damaged, because the inside of the flow pass C is filled with liquid.

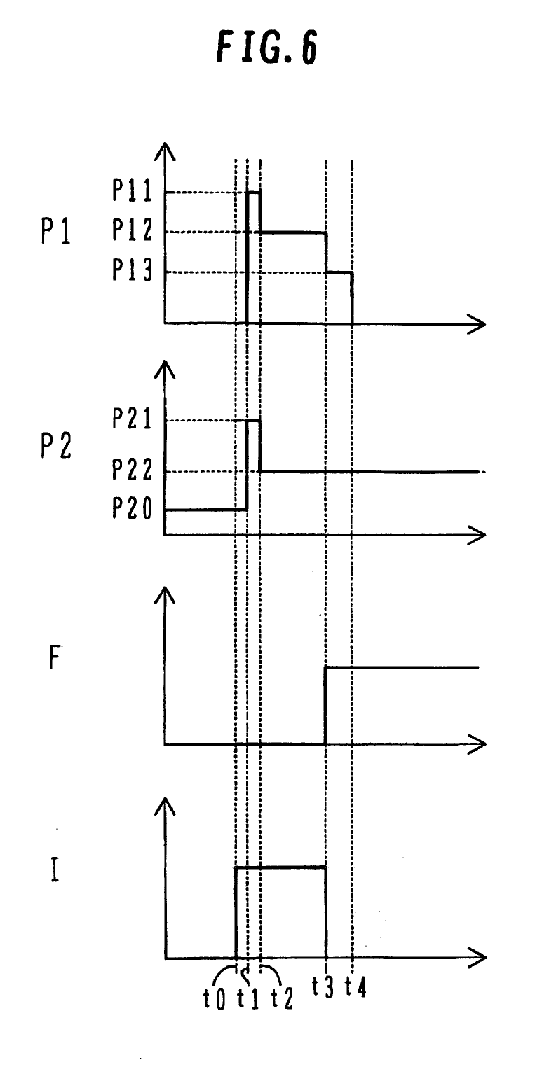

Next, with reference to FIG. 6, description will be made on a method of suppressing damages of the flow pass C of the molding apparatus of the embodiment. FIG. 6 is a timing chart illustrating a change during a molding process in a pressure P1 applied to the design surface 4a by molding material, a pressure P2 applied to cooling water by the pump 6c shown in FIG. 1, a flow rate F of cooling water passing through the valve 6d, and a current I flowing through the heater H.

Pressure application to the design surface 4a starts at time t1 and ends at time t4. A pressure applied to the design surface 4a is highest during an initial pressure application period from time t1 to time t2. The pressure during this period is represented by P11. Thereafter, during a period from time t2 to time t3, a pressure P12 lower than the pressure P11 is applied. Thereafter, during a period from time t3 to time t4, a pressure P13 lower than the pressure P12 is applied. Time t3 is a time when the concave portions of the molding pattern on the design surface 4a are completely filled with the molding material. The pressure P13 applied to the design surface 4a during the period from time t3 to time t4 is a retention pressure used for not breaking the structure transferred to the molding material.

Energizing the heater H starts at time 0 slightly before time t1 to heat the design surface 4a. Energizing the heater H continues until time t3.

During a period before time t1, cooling water is filled in the flow pass C without any space. During this period, the pump 6c applies a constant pressure P20 to the cooling water. Also during this period, the valve 6d is closed so that the cooling water does not flow out of the flow pass C. If the pressure P20 is too high, the cooling water pushes upward the lower silicon member 12a shown in FIG. 2A and the bonding structure between the lower silicon member 12a and heat insulating member 14 is broken. The pressure P20 has a strength near a strength not breaking the bonding structure.

During the period from time t1 to time t4 while a pressure is applied to the design surface 4a, the pump 6c applies a pressure higher than the pressure P20 to the cooling water to raise a pressure applied to the inner wall of the flow pass C by the cooling water, higher than the pressure during the period before time t1. A pressure applied to the cooling water by the pump 6c is set at a value capable of protecting the flow pass C not to be crushed.

The pump 6c applies to the cooling water a pressure P21 corresponding to the pressure P11 applied to the design surface 4a, during the period from time t1 to time t2, and a pressure P22 corresponding to the pressure P12 applied to the design surface 4a, during the period from time t2 to time t3. In correspondence with the pressure P11 higher than the pressure P12. the pressure P22 is higher than the pressure P21. During the period from time t1 to time t3, the valve 6d is maintained to be closed.

Even after time t3, the pressure applied to the cooling water by the pump 6c is maintained at P22. The valve 6d is opened at time t3. After time t3, the cooling water flows through the flow pass C to cool the design surface 4a. A pressure applied to the cooling water by the pump 6c after time t3 may be different from the pressure P22 applied during the period from time t2 to time t3.

As described above, by using the molding apparatus of the embodiment, the flow pass C can be suppressed from being damaged by the molding material pushed against the design surface 4a.

In the above description, during the period from time t1 to time t3, the valve 6d is closed not to flow the cooling water through the flow pass C. If the pressure applied to the cooling water by the pump 6c is raised in the state that the valve 6d is closed, it is advantageous in that a pressure applied to the inner wall of the flow pass C by the cooling water can be raised more easily than the pressure applied to the cooling water by the pump 6c is raised in the state that the valve 6d is opened.

If damages of the flow pass C can be suppressed sufficiently, the cooling water may flow to some extent through the flow pass C during the period from time t1 to time t3. However, a flow rate of the cooling water is suppressed in such a manner that heating by the heater H can be conducted satisfactorily.

The pressure applied to the inner wall of the flow pass C by the cooling water may be raised by adjusting the flow rate with the valve 6d.

A valve for adjusting a flow rate of the cooling water flowing into the flow pass C may be provided to raise the pressure applied to the inner wall of the flow pass C by the cooling water, by flow rate adjustment by this valve.

Although the heater H is disposed near the flow pass C through which the cooling water flows, it is possible to prevent a boiling point of the cooling water from rising and prevent boiling, because a proper pressure is applied to the cooling water.

In the embodiment described above, although water is used as a thermal medium flowing through the flow pass C, other thermal media may also be used such as Fluorinert (product of Sumitomo 3M Limited).

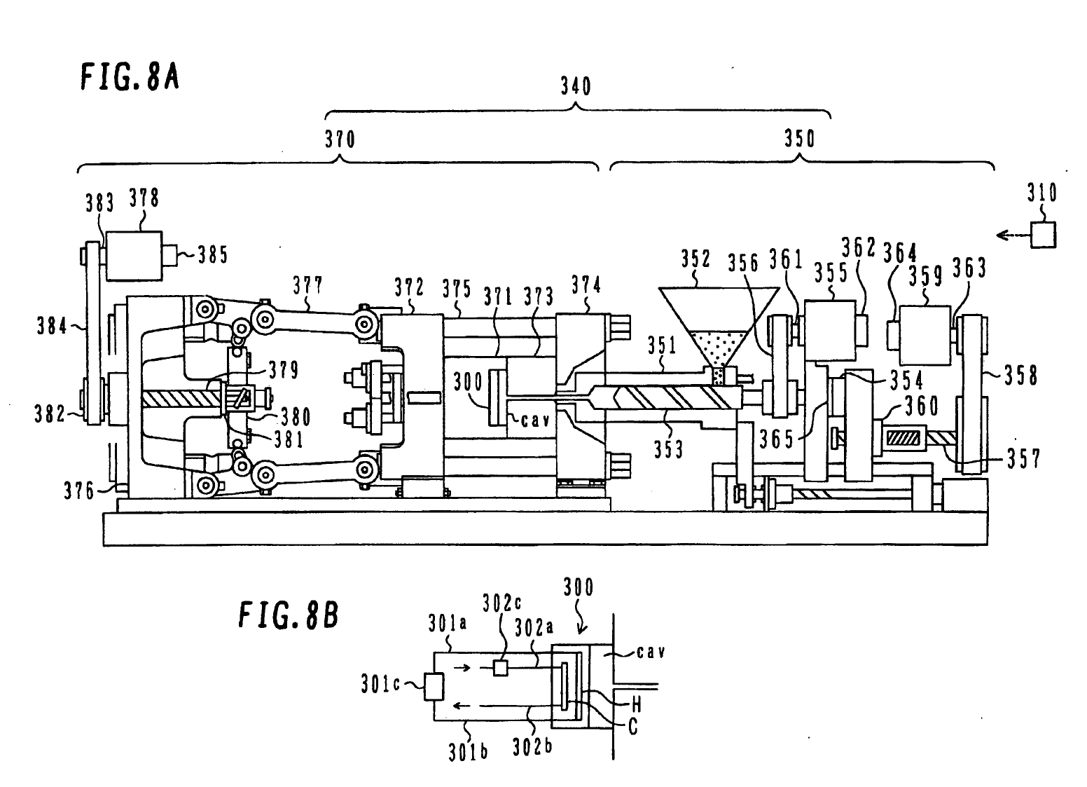

Next, a molding apparatus of the second embodiment will be described. FIG. 8A is a schematic diagram showing a molding apparatus (electrically operated injection molding apparatus). An injection molding apparatus 340 is constituted of an injection apparatus 350 and a die clamping apparatus 370.

The injection apparatus 350 has a heating cylinder 352 and a hopper 352 for supplying resin to the heating cylinder 351. A screw 353 is disposed in the heating cylinder 351, freely moving backward and forward and freely rotating. The back end of the screw 353 is rotatively supported by a support member 354. A weighing motor 355 such as a servo motor is mounted on the support member 354 as a drive part. Rotation of the weighing motor 355 is transmitted to the driven screw 353 via a timing belt 356 mounted on an output shaft 361 of the weighing motor 355. A detector 362 is directly coupled to the back end of the output shaft 361 of the weighing motor 355. The detector 362 detects a rotation number or amount of the weighing motor 355. In accordance with the rotation number or amount detected with the detector 362, a rotation speed of the screw 353 is obtained.

The injection apparatus 350 has a thread shaft 357 rotatively supported in parallel to the screw 353. The back end of the thread shaft 357 is coupled to an injection motor 359 such as a serve motor via a timing belt 358 mounted an output shaft 363 of the injection motor 359, so that the thread shaft 357 can be rotated by the injection motor 359. The front end of the thread shaft 357 is threaded with a nut 360 fixed to the support member 354. The support member 354 moves forward and backward as the injection motor 359 as the drive part is driven to rotate the thread shaft 357 as the drive transmission part via the timing belt 358.

A load cell 365 as a load detector is mounted on the support member 354. Fore and aft motions of the of the support member 354 is transmitted to the screw 353 via the load cell 365 so that the screw 353 moves forward and backward. Data corresponding to a force detected with the load cell 365 is sent to a controller 310. A detector 364 is directly coupled to the back end of the output shaft 363 of the injection motor 359. The detector 364 detects a rotation number or amount of the injection motor 359. In accordance with the rotation number or amount detected with the detector 364, a motion speed along a fore and aft motion direction or a position along the fore and aft motion direction of the screw 353 is obtained.

The die clamping apparatus has a movable platen 372 mounting a movable side die 371 and a fixed platen 374 mounting a fixed side die 373. The movable platen 372 and fixed platen 374 are coupled by tie bars 375. The movable platen 372 can slide along the tie bars 375. The die clamping apparatus 370 has also a toggle mechanism 377. The toggle mechanism 377 is coupled at one end to the movable platen 372, and at the other end to a toggle support 376. A ball thread shaft 379 is rotatively supported at the center of the toggle support 376. A nut 381 fixed to a cross head 380 mounted on the toggle mechanism 377 is threaded with the ball thread shaft 379. A pulley 382 is mounted on the back end of the ball thread shaft 379, and a timing belt 384 extends between an output shaft 383 of a die clamping motor 378 such as a servo motor and the pulley 382.

As the die clamping motor 378 as a drive part of the die clamping apparatus 370 is driven, a rotation of the die clamping motor 378 is transmitted to the ball thread shaft 379 as a drive transmission part via the timing belt 384. The ball thread shaft 379 and nut 381 convert a rotary motion into a linear motion to drive the toggle mechanism 377. As the toggle mechanism 377 is driven, the movable platen 372 slides along the tie bars 375 to conduct die closing, die clamping and die opening.

A detector 385 is directly coupled to the back end of an output shaft 383 of the die clamping motor 378. The detector 385 detects a rotation number or rotation amount of the die clamping motor 378. In accordance with the rotation number or rotation amount detected with the detector 385, a position of the cross head 380 moving forward and backward in response to the rotation of the ball thread shaft 379 or a position of the movable platen 372 as a driven part coupled to the cross head 380 by the toggle mechanism 377 is obtained. The controller 310 controls the weighing motor 355, injection motor 359 and die clamping motor 378.

A cavity cav is formed between the movable side die 371 and fixed side die 373. The cavity cav communicates with the inside of the heating cylinder 351. A structural body 300 similar to the plunger upper structural body 4C shown in FIG. 5A is disposed in a region of the movable side die 371 facing the cavity cav. The design surface is disposed facing the cavity cav. A size of the design surface of the structural body 300 may be larger than the size of 2 to 3 mm illustratively given with reference to FIG. 2B.

As shown in FIG. 8B, the structural body 300 has a heater H and a flow pass C through which cooling water flows. The heater H is connected to a power source 301c via lead wires 301a and 301b. The flow pass C is connected to a water feed flow pass 302a and a water drain flow pass 302b. A pump 302c regulates a pressure of the cooling water flowing into the flow pass C. The controller 310 controls the pump 302c.

Next, description will be made on a molding method using the molding apparatus of the second embodiment. First, the weighing motor 355 is driven to rotate the screw 353 so that resin dropped on a back end portion of the screw 353 from the hopper 352 is sent to the front end portion of the heating cylinder 351 while the resin is being melted. As the resin becomes resident at the front end of the heating cylinder 351, the screw 353 is retracted.

Next, the injection motor 359 operates to move the screw 353 forward to make the cavity cab be filled with resin. After the cavity cav is filled with resin, the screw 353 operates to apply a retention pressure to the resin. The retention pressure is applied not to lower a transfer precision to be caused by contraction of cooled resin. In this manner, the resin is pushed against the design surface so that the molding pattern of the design surface is transferred to the resin. Next, after the resin in the cavity cav is cooled sufficiently, the die is opened and the mold product is picked up.

A period from when the cavity cav starts being filled with resin to when the retention pressure starts being applied, is called a filling period. A period from the start to end of application of the retention pressure is called a retention pressure period. In order to suppress damages of the flow pass C during the filling period and retention pressure period, a pressure applied to the thermal medium flowing through the flow pass C is increased by the pump 302c.

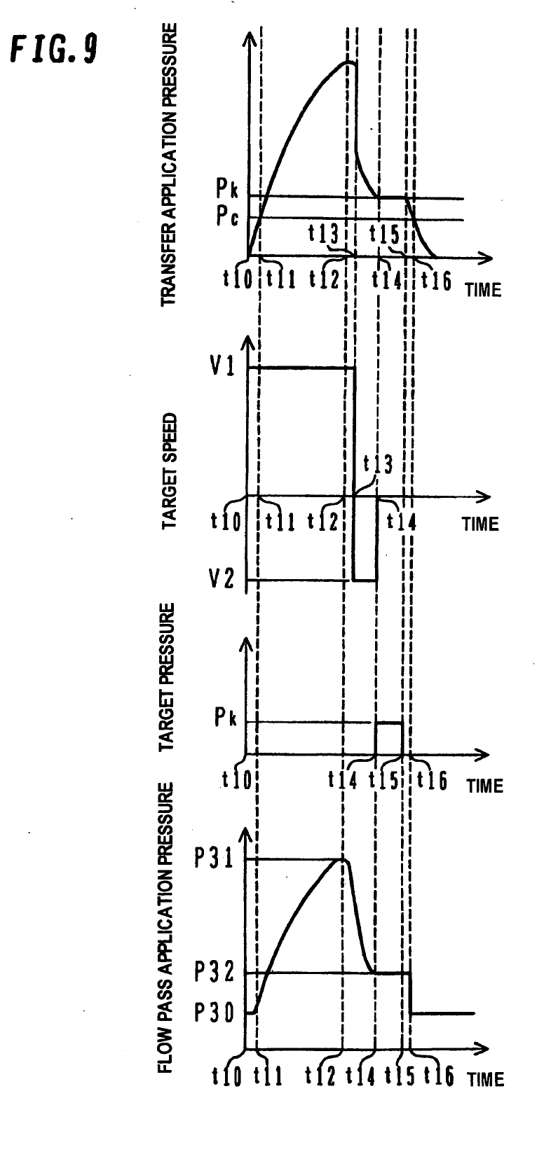

Next, with reference to FIG. 9, description will be made on a change with time in a pressure (this pressure is called a transfer application pressure) applied to resin by the screw 353 during the filling period and retention pressure period. The transfer application pressure is obtained from a force detected with the load cell 365 shown in FIG. 8A. A graph in the uppermost row in FIG. 9 indicates a change with time in the transfer application pressure. The start and end times of the filling period are time t10 and time t14, respectively. The start and end times of the retention pressure period are time t14 and time t15, respectively.

As the filling period starts, the transfer application pressure increases and becomes maximum at time t12. After becoming maximum at time t12, the transfer application pressure lowers and reaches a setting value Pk of the retention pressure at the end time t14 of the filling period. The transfer application pressure is maintained at the setting value Pk during the retention pressure period from time t14 to time t15. As the retention pressure application is released after time t15, the transfer application pressure lowers from the setting value Pk.

Next, description will be made on a method of controlling the injection motor 359 to change the transfer application pressure in the manner described above. This control method for the injection motor 359 is disclosed in JP-A-2001-277322. The injection motor 359 is controlled in a speed control mode during the filling period, and in a pressure control mode during the retention pressure period. A graph in the second uppermost row in FIG. 9 shows a target speed of the screw 353 in the speed control mode. A graph at the third uppermost row in FIG. 9 shows a target pressure applied to resin by the screw 353 in the pressure control mode.

First, the speed control mode will be described. After the filling period starts, the screw 353 is moved forward to a first setting position. A time when the screw 353 reaches the first setting position is t13. During the period (time t10 to time t13) until the screw 353 reaches the first setting position, the injection motor 359 is controlled so that a speed of the screw 353 maintains a target speed V1.

After the screw 353 reaches the first setting position, the screw 353 is moved backward to a second setting position. A time when the screw 353 reaches the second setting position is time t14. During the period (time t13 to time t14) while the screw 353 starts the first setting position and reaches the second setting position, the injection motor 359 is controlled so that a speed of the screw 353 maintains a target speed V2.

As the screw 353 moves forward, the transfer application pressure increases. During the period while the screw 353 moves forward, the transfer application pressure reaches a maximum value. After the screw 353 is moved to the first setting position, the screw 353 is moved backward so that the transfer application pressure can be lowered quickly to a retention pressure setting value Pk.

Next, the pressure control mode will be described. Until a start time t14 of the retention pressure period, the transfer application pressure has lowered to the retention pressure setting value Pk. The injection motor 359 is controlled so that the transfer application pressure is maintained at the retention pressure setting value Pk during the retention pressure period from time t14 to time t15.

Next, with reference also to FIG. 9, description will be made on a time change in a pressure (this pressure is assumed to be called a flow pass application pressure) applied to a thermal medium flowing in the flow pass C by the pump 302c during the filling and retention pressure periods. A graph in the lowermost row in FIG. 9 shows the time change in the flow pass application pressure. As shown in the graph of the transfer application pressure, a threshold value Pc is set for the transfer application pressure. The threshold value Pc is lower than the retention pressure setting value Pk.

Before the start of the filling period, a constant flow pass application pressure P30 is applied. When the filling period starts, the transfer application pressure increases and reaches the threshold value Pc at time t11. After the transfer application pressure takes the threshold value Pc, the flow pass application pressure is also increased from P30. During the period while the transfer application pressure rises, the flow pass application pressure rises also. Simultaneously when the transfer application pressure takes the maximum value at time t12, the flow pass application pressure takes a maximum value P31 at time t12. After the transfer application pressure takes the maximum value, it lowers and takes the constant value Pk. After the flow pass application pressure takes the maximum value, it is lowered to a value P32 corresponding to the retention pressure setting value Pl. After the retention pressure period, the transfer application pressure lowers from Pk and reaches the threshold value Pc at time t16. After the transfer application pressure takes the threshold value Pc, the flow pass application pressure is lowered to P30.

The controller 310 controls the pump 302c basing upon the transfer application pressure so that the flow pass application pressure changes in the manner described above. The flow pass application pressure may be controlled by adjusting the flow rate by the valve.

A force detected with the load cell 365 is in correspondence with the transfer application pressure. Therefore, a threshold value corresponding to the threshold value Pc of the transfer application pressure may be set for a force detected with the load cell 365 to control the flow pass application pressure in accordance with a time change in the force detected with the load cell 365.

As described above, in the molding apparatus of the second embodiment, a pressure applied to the inner wall of the flow pass C by a thermal medium is increased in accordance with (synchronously with) the timing when molding material is pushed against the design surface by the screw 353, to suppress damages of the flow pass C.

The distance from the design surface to the heater has a range suitable for good heating. If the distance from the design surface to the heater is too long, the design surface cannot be heated sufficiently, whereas if the distance from the design surface to the heater is too short, it is difficult to heat the design surface uniformly. The shortest distance from the design surface to the heater is preferably set to five to ten times the maximum depth of the concave portions of the design surface, from the view point of heating the design surface sufficiently while suppressing an irregular temperature distribution.

Consider now a heater having the structure that linear heat generating portions are juxtaposed at a constant pitch along a direction crossing the longitudinal direction of the linear heat generating portion (for example, the heater H shown in FIG. 2B). In the heater of this structure, the pitch at which the linear heat generating portions are disposed (a center distance between adjacent two linear heat generating portions) is set to ⅕ to ¼ time the shortest distance from the design surface to the heater. In this case, particularly, irregular heating of the design surface can be suppressed easily.

With reference again to FIGS. 2A and 2B, description will be made on examples of the position and size of the heater H particularly suitable for good heating. First, a first example will be described. In the transfer structural body 11, a thickness of the seed layer 11a is several ten nm, and a height of the columnar structural body 11b is 20 μm. In this example, the height of 20 μm of the columnar structural body 11b is the maximum depth of the concave portions of the design surface 4a. A depth from the upper surface of the seed layer 11a to the upper surface of the heater H is 120 μm. In this example, the depth of 120 μm from the upper surface of the seed layer 11a to the upper surface of the heater H is the shortest distance from the design surface 4a to the heater H.

A depth from the upper surface of the seed layer 11a to the upper surface of the flow pass C (the shortest distance from the design surface 4a to the flow pass C) is 150 μm. A thickness of the silicon member 12 is about 150 μm (a thickness of 150 μm subtracted by the thickness of the seed layer 11a). A line width of the heater H is 15 μm, and a pitch at which the linear portions of the heater H are disposed (a center distance between a downward portion and an upward portion of the heater H having a zig-zag shape) is 30 μm.

A second example will be described. In the transfer structural body 11, a thickness of the seed layer 11a is several ten nm, and a height of the columnar structural body 11b is 80 μm. In this example, the height of 80 μm of the columnar structural body 11b is the maximum depth of the concave portions of the design surface 4a. A depth from the upper surface of the seed layer 11a to the upper surface of the heater H is 400 μm. In this example, the depth of 400 μm from the upper surface of the seed layer 11a to the upper surface of the heater H is the shortest distance from the design surface 4a to the heater H.

A depth from the upper surface of the seed layer 11a to the upper surface of the flow pass C (the shortest distance from the design surface 4a to the flow pass C) is 500 μm. A thickness of the silicon member 12 is about 500 μm (a thickness of 500 μm subtracted by the thickness of the seed layer 11a). A line width of the heater H is 45 μm, and a pitch at which the linear portions of the heater H are disposed (a center distance between a downward portion and an upward portion of the heater H having a zig-zag shape) is 90 μm.

One feature of the molding apparatus of the embodiment is that the thickness from the upper surface of the seed layer 11a to the upper surface of the heater H can be made thin easily. The shortest distance from the design surface to the heater is 1 mm or shorter. The shorter the distance from the design surface to the heater is, it is easy to perform heating quickly.

A thickness of the heater H is in a range, e.g., from 0.1 μm to 1 μm. A heat quantity necessary for heating is determined from a molding cycle and mold product. A thickness of the heater is determined from the molding cycle and mold product.

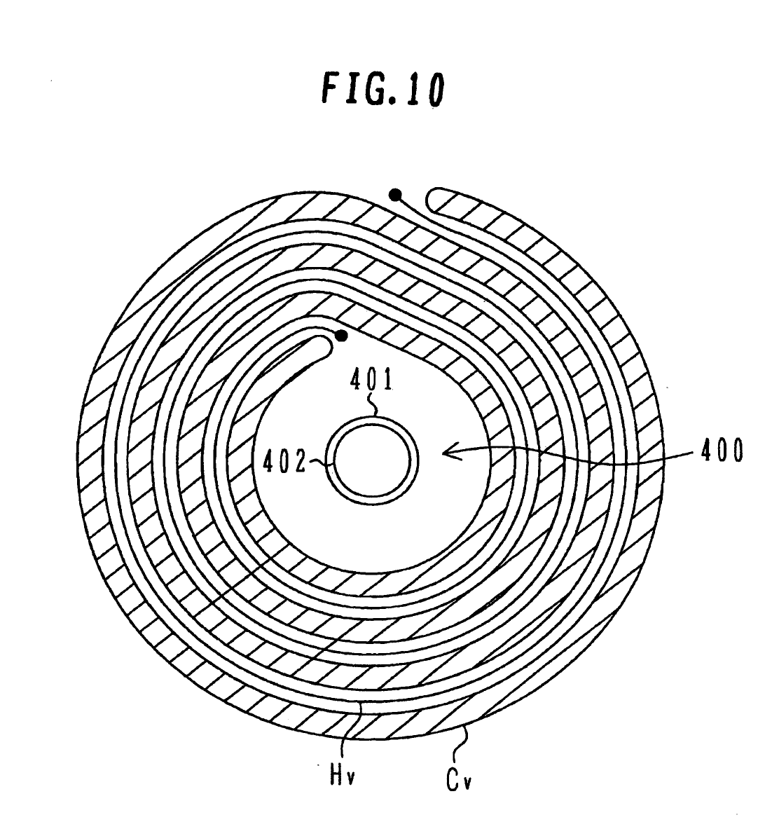

The shapes of the flow pass and heater as viewed in plan may be different from those illustratively shown in FIG. 2B. For example, as shown in FIG. 10, a flow pass Cv and a heater Hv may have a spiral shape. In FIG. 10, the flow pass is hatched. The heater Hv is disposed between adjacent portions of the spiral flow pass Cv (or the flow pass Cv may be disposed between adjacent portions of the spiral heater Hv). A vortex center portion is common for both the flow pass Cv and heater Hv. The flow pass Cv and heater Hv do not cross as viewed in plan. A water feed flow pass is connected to one end of the flow pass Cv, and a water drain flow pass is connected to the other end.

In molding technologies, a protruding mechanism is generally used for pushing a molded product from the design surface side to dismount the molded product from the design surface. It is assumed that a structure to be transferred is not formed near at the center of the design surface as viewed in plan. For example, in this case, a protruding member can be disposed in the area near the center of the design surface where the structure to be transferred is not formed.

As the flow pass Cv and heater Hv having the shape shown in FIG. 10 are used, an area 400 where the flow pass Cv and heater Hv are not formed is easy to be disposed near the vortex center (near the center of the design surface). If this area 400 is provided, it becomes easy to form in this area 400 a through hole 401 extending from the heat insulating member side to the design surface side and to dispose a protruding member 402 in the through hole 401.

The spiral cooling flow pass shown in FIG. 10 may be divided into a plurality of flow passes along the longitudinally direction, and a water feed flow pass and a water drain flow pass are connected to each flow pass. In this case, a pressure loss of cooling water can be suppressed while the cooling water flows in the cooling flow pass from the water feed flow pass to the water drain flow pass. It is therefore possible to improve a response of pressure control in the flow pass and shorten the molding cycle.

In the second embodiment, after the cavity cav is formed by the movable side die 371 and the fixed side die 373, resin is pushed against the design surface as the screw 353 moves forward. However, resin may be filled by a predetermined amount in a state that the movable side die 371 and the fixed side die 373 are spaced apart slightly, i.e., before the cavity cav is formed perfectly. In this case, after the filling, the resin is pushed against the design surface as the movable side die 371 moves forward by a drive force of the die clamping motor 378. A load on the injection motor 359, thread shaft 357 and the like constituting the injection apparatus 350 can be reduced and the component lifetime can be elongated, resulting in the improvement on productivity of mold products.

In the embodiments described above, the transfer structural body (structural body defining the design surface) is formed on the silicon member by LIGA. A design surface defining structural body manufactured in advance may be mounted on the silicon member.

In the embodiments described above, the heater is buried in the silicon member. Material in which the heater is buried is not limited to silicon. The material of the member in which the heater is buried may be other materials which are electrically insulating and excellent in heat propagation, such as aluminum nitride and diamond-like carbon.

The present invention has been described in connection with the preferred embodiments. The invention is not limited only to the above embodiments. It will be apparent to those skilled in the art that other various modifications, improvements, combinations, and the like can be made.

What we claim are:

1. A molding apparatus comprising:
a first member;
a second member disposed in a partial surface area of said first member, said second member including a design surface formed with a molding pattern on a surface on an opposite side to said first member; and
a flow pass whose inner wall is defined cooperatively by a surface of said first member and a surface of said second member, said flow pass flowing therein a thermal medium for heat exchange with said second member.

2. The molding apparatus according to claim 1, wherein said first member is a heat insulating member, and said second member is made of material having a higher thermal conductivity than a thermal conductivity of said first member.

3. The molding apparatus according to claim 1, wherein a shortest distance from said flow pass to said design surface is 100 μm to 200 μm.

4. The molding apparatus according to claim 1, further comprising:
a pushing mechanism that pushes molding material against said design surface;
an adjusting mechanism that changes at least one of a pressure applied to said thermal medium in said flow pass and a flow rate of said thermal medium flowing in said flow pass, in accordance with a control signal externally input; and
a controller that controls said adjusting mechanism to increase a pressure applied to the inner wall of said flow pass by said thermal medium, in accordance with a timing when the molding material is pushed against said design surface by said pushing mechanism.

5. The molding apparatus according to claim 4, wherein:
said adjusting mechanism includes a pump that changes a pressure applied to said thermal medium in said flow pass and a valve that switches between a state that said thermal medium flows in said flow pass and a state that said thermal medium does not flow in said flow pass; and
said controller controls said valve to enter the state that said thermal medium does not flow in said flow pass, and controls said pump to increase a pressure applied to said thermal medium in said flow pass.

6. The molding apparatus according to claim 4, wherein:
said pushing mechanism includes a pushing member that pushes the molding material against said design surface;
the molding apparatus further comprises a detector that detects a force of pushing the molding material by said pushing member; and
said controller controls said adjusting mechanism to increase a pressure of said thermal medium applied to the inner wall of said flow pass, in accordance with a timing when the force detected with said detector takes a threshold value or higher.

7. A molding apparatus comprising:
a first member;
a second member disposed in a partial surface area of said first member, said second member including a design surface formed with a molding pattern on a surface on an opposite side to said first member, and being made of material having a higher thermal conductivity than a thermal conductivity of said first member;
a heater that heats a surface layer of said second member on a side of said design surface, from an inside of said second member; and
a flow pass disposed between said first member and said design surface, that flows thermal medium for heat exchange with said second member.

8. The molding apparatus according to claim 7, wherein said flow pass is disposed between said first member and said second member.

9. The molding apparatus according to claim 7, wherein an inner wall of said flow pass is defined cooperatively by a surface of said first member and a surface of said second member.

10. The molding apparatus according to claim 7, wherein a shortest distance from said flow pass to said design surface is 100 μm to 200 μm.

11. The molding apparatus according to claim 7, wherein said second member includes an insulating member made of material having electrical insulation, and said heater includes a conductive member buried in said insulating member.

12. The molding apparatus according to claim 7, further comprising:
a pushing mechanism that pushes molding material against said design surface;
an adjusting mechanism that changes at least one of a pressure applied to said thermal medium in said flow pass and a flow rate of said thermal medium flowing in said flow pass, in accordance with a control signal externally input; and
a controller that controls said adjusting mechanism to increase a pressure applied to the inner wall of said flow pass by said thermal medium, in accordance with a timing when the molding material is pushed against said design surface by said pushing mechanism.

13. The molding apparatus according to claim 12, wherein:
said adjusting mechanism includes a pump that changes a pressure applied to said thermal medium in said flow pass and a valve that switches between a state that said thermal medium flows in said flow pass and a state that said thermal medium does not flow in said flow pass; and
said controller controls said valve to enter the state that said thermal medium does not flow in said flow pass, and controls said pump to increase a pressure applied to said thermal medium in said flow pass.

14. The molding apparatus according to claim 12, wherein:
said pushing mechanism includes a pushing member that pushes the molding material against said design surface;
the molding apparatus further comprises a detector that detects a force of pushing the molding material by said pushing member; and
said controller controls said adjusting mechanism to increase a pressure of said thermal medium applied to the inner wall of said flow pass, in accordance with a timing when the force detected with said detector takes a threshold value or higher.

15. A molding apparatus comprising:
a third member including a design surface formed with a molding pattern; and
a heater disposed on said third member that heats a surface layer of said third member on a side of said design surface,
wherein a shortest distance from said heater to said design surface is five to ten times a maximum depth of concave portions of said design surface.

16. The molding apparatus according to claim 15, wherein said heater includes an equal pitch portion having linear heat generating portions disposed at a constant pitch along a direction crossing a longitudinal direction of the linear heat generating portions, said constant pitch is ⅕ to ¼ time a shortest distance from said heater to said design surface.

17. The molding apparatus according to claim 15, wherein said third member includes an insulating member made of material having electrical insulating, and said heater includes a conductive member buried in said insulating member.

18. The molding apparatus according to claim 15, further comprising a fourth member, said third member is disposed on a surface of said fourth member, made of material having a thermal conductivity higher than a thermal conductivity of said fourth member, and includes said design surface on a surface on an opposite side to said fourth member.

19. The molding apparatus according to claim 15, wherein a shortest distance from said heater to said design surface is 1 mm or shorter.

20. A manufacture method for a molding apparatus, comprising steps of:
(a) partially etching a first surface of a first member to form a groove; and
(b) bonding said first surface of said first member to a second surface of a second member, the second member including a design surface formed with a molding pattern opposite to the second surface, said second member being made of material having a thermal conductivity higher than a thermal conductivity of said first member, to form a flow pass defined by an inner wall of said groove and the second surface of said second member.

21. The manufacture method for a molding apparatus according to claim 20, further comprising steps of:
(c) forming a conductive layer made of conductive material on a surface of an insulating support member made of material having electrical insulation;
(d) patterning said conductive layer to form a heater;
(e) covering said heater with material having electrical insulation to form an insulating member; and
(f) laminating a transfer structural body including said design surface on said insulating member to form said second member.

22. The manufacture method for a molding apparatus according to claim 21, wherein said transfer structural body is formed on said insulating support member by LIGA.

23. A manufacture method for a molding apparatus comprising steps of:
(g) laminating a transfer structural body including a design surface formed with a molding pattern, on a surface of an insulating support member made of material having electrical insulation;
(h) forming a conductive layer made of conductive material on a surface of said insulating support member on an opposite side to a side laminating said transfer structural body; and
(i) patterning said conductive layer to form a heater.

24. The manufacture method for a molding apparatus according to claim 23, wherein said transfer structural body is formed on said insulating support member by LIGA.

25. A molding method comprising steps of:
(j) pushing molding material against a design surface of a structural body including said design surface formed with a molding pattern on a surface and a flow pass therein that flows a thermal medium for heat exchange with said design surface; and
(k) changing at least one of a pressure applied to said thermal medium in said flow pass and a flow rate of said thermal medium flowing in said flow pass, in accordance with a timing when the molding material is pushed against said design surface, to increase a pressure applied to an inner wall of said flow pass by said thermal medium.

26. The molding method according to claim 25, wherein:
a pushing member pushes the molding material against said design surface in said step (j);
the manufacture method further comprises a step of (l) detecting a force of pushing the molding material against the design surface by said pushing member;
said step (k) changes at least one of the pressure applied to said thermal medium in said flow pass and the flow rate of said thermal medium flowing in said flow pass, in accordance with a timing when the force detected in said step (l) takes a threshold value or higher, to increase a pressure applied to the inner wall of said flow pass by said thermal medium.
